(19) United States
(12) Patent Application Publication
(10) Pub. No.: US 2012/0087414 A1
(43) Pub. Date: Apr. 12, 2012

(54) APPARATUS AND METHOD FOR PROCESSING VIDEO DATA

(75) Inventor: Seungpyo Shin, Seoul (KR)

(73) Assignee: CORE LOGIC INC., Seoul (KR)

(21) Appl. No.: 13/375,641

(22) PCT Filed: Mar. 17, 2010
(86) PCT No.: PCT/KR10/01638

§ 371 Date: Dec. 1, 2011

(30) Foreign Application Priority Data
Jun. 4, 2009 (KR) 10-2009-0049547

(51) Int. Cl. H04N 7/26

(52) U.S. Cl. 375/240.24; 375/E07.027

(57) ABSTRACT

An apparatus and method for processing video data is disclosed. In an embodiment, the video data processing apparatus comprises a decoding unit configured to decode a frame image, divided into a number of slices and then encoded, on a slice basis and to deblock-filter a number of the decoded slices except boundary portions between the decoded slices and a slice edge deblock filter unit configured to comprise a number of slice edge deblock filters operated in conjunction with the decoding unit and to in parallel deblock-filter the boundary portions between the decoded slices using a number of the slice edge deblock filters. Accordingly, the boundary portions between slices can be efficiently deblock-filtered.

### TECHNICAL FIELD

The present invention relates to an apparatus and method for processing video data, and more particularly, to video data processing technique capable of processing a frame image, divided into a number of slices, on a slice basis and in parallel deblock-filtering boundary portions between slices.

### BACKGROUND ART

When video data are stored or transmitted, the amount of the video data needs to be reduced through compression because it is, in general, greater than the amount of text data or voice data. A video codec is used to compress and encode video data and to restore compressed and encoded video data. Video codecs complying with various standards, such as MPEG-1, MPEG-2, H.263, and H.264/MPEG-4, are being widely used.

A video codec compresses and encodes an enormous amount of video data by, basically, removing spatial redundancy and temporal redundancy within an image and displaying the processed image in the form of preset bit streams with a much shorter length. To remove the spatial redundancy within the image, the video codec can remove high frequency components, which are insensitive to a person s eyes and occupy a large amount of information, through Discrete Cosine Transform (DCT) and quantization. The video codec can remove temporal redundancy (i.e., the similarity between frames) by not transmitting data with similar portions through the detection of the similarity between frames, but transmitting error components occurring when the data are displayed in the form of corresponding motion vectors and information about the motion vectors. The video codec may also reduce the amount of data using Variable Length Code (VLC) technique for assigning a shorter code value to a bit stream which frequently occurs.

The above-described video codec compresses, encodes, and decodes an image for every block composed of a number of pixels (e.g., on a Macro-Block (MB) basis). For example, when compressing and encoding an image, the video codec performs a series of processes, such as DCT and quantization, on a block basis. However, when the compressed and encoded image is restored through decoding, a distortion resulting from a blocking phenomenon is inevitably generated. The blocking phenomenon can refer to a phenomenon in which the boundary portion between blocks in a restored image discontinuously appears to the extent that the boundaries can be recognized by the eyes of a person, because of the loss of an input image occurring in the quantization process and a difference in the pixel value between neighbor blocks near the boundary of the blocks.

To remove such a distortion resulting from the blocking phenomenon when an image is compressed and encoded or decoded, a deblock filter is used. The deblock filter can improve the quality of a restored image by making smooth the boundary portion between decoded macro blocks. A frame image processed by the deblock filter is used to predict the motion compensation of a future frame or is transferred to a display device for the purpose of play.

Meanwhile, technique for dividing a video frame image into a number of slices and compressing and encoding the slices is recently being used. For example, a frame image can be divided into a specific number of slices and the slices are independently encoded. The encoded slices can be individually decoded and then merged in order to restore the frame image.

In the case in which as described above, the frame image is divided into a number of the slices and the slices are compressed and encoded, a distortion resulting from the blocking phenomenon can be generated at the boundary portion between the compressed and encoded slices. In conventional video codecs, deblock filtering for the boundary portion between the slices is omitted or all the slices are sequentially decoded using a single operation processor and deblock filtering for the boundary portion between the decoded slices is then performed.

However, in the former case, there is a problem in that an image having a high picture quality cannot be restored because of a distortion occurring at the boundary portion between the slices. The latter case is problematic in that the use efficiency of computing resources is low and the data processing time is delayed. Accordingly, there is an urgent need for technique which is capable of efficiently deblock-filtering the boundary portion between slices in a system for dividing an image into a number of slices and compressing and encoding the slices.

### DISCLOSURE OF INVENTION

### Technical Problem

It is an object of the present invention to provide an apparatus and method for processing video data, which is capable of processing a frame image, divided into a number of slices, on a slice basis and in parallel deblock-filtering the boundary portions between the slices.

### Solution to Problem

To achieve the above object, an aspect of the present invention provides a video data processing apparatus. The video data processing apparatus comprises a decoding unit configured to decode a frame image, divided into a number of slices and then encoded, on a slice basis and to deblock-filter a number of the decoded slices except boundary portions between the decoded slices and a slice edge deblock filter unit configured to comprise a number of slice edge deblock filters operated in conjunction with the decoding unit and to in parallel deblock-filter the boundary portions between the decoded slices using a number of the slice edge deblock filters.

Each of the slice edge deblock filters may be provided in response to at least two neighbor slices of a number of the decoded slices and be configured to deblock-filter a boundary portion between the at least two neighbor slices.

Each of the slice edge deblock filters may be provided in response to at least two neighbor slices of a number of the decoded slices and be configured to determine whether the decoding unit has completed the deblock filtering for the two slices based on specific information received the decoding unit and to deblock-filter a boundary portion between the two slices if, as a result of the determination, the deblock filtering for the two slices is determined to have been completed.

The decoding unit may comprise a number of decoders provided in response to a number of the slices. In this case, each of the slice edge deblock filters may operate in conjunction with at least two of a number of the decoders, corresponding to at least two neighbor slices of a number of the slices, and deblock-filter a boundary portion between the at least two slices respectively decoded and deblock-filtered by the at least two decoders.

Each of the decoders may operate in conjunction with at least one of the slice edge deblock filters and, after the deblock filtering for a corresponding slice is completed, send information, informing that the deblock filtering for the corresponding slice has been completed, to the at least one slice edge deblock filter.

Each of the slice edge deblock filters may receive pieces of information, informing that the deblock filtering for the at least two slices has been completed, from at least two neighbor decoders of a number of the decoders, load data of a boundary portion between the at least two slices from a frame buffer based on the received information, and deblock-filter the loaded data. On the other hand, each of the slice edge deblock filters may deblock-filter a boundary portion between neighbor slices of a number of the slices and sends deblock-filtered data to a frame buffer.

To achieve the above object,another aspect of the present invention provides a video data processing method. The video data processing method comprises decoding a frame image, divided into a number of slices and then encoded, on a slice basis; deblock-filtering a number of the decoded slices except boundary portions between the decoded slices; and in parallel deblock-filtering the boundary portions between a number of the decoded slices using a number of slice edge deblock filters.

In parallel deblock-filtering the boundary portions between a number of the decoded slices using a number of slice edge deblock filters may comprise, using each of the slice edge deblock filters, determining whether the deblock filtering for two neighbor slices of a number of the decoded slices has been completed and if, as a result of the determination, the deblock filtering for the two neighbor slices is determined to have been completed, deblock-filtering a boundary portion between the two neighbor slices using a corresponding slice edge deblock filter.

To achieve the above object, yet another aspect of the present invention provides a video data processing apparatus. The video data processing apparatus comprises an encoding unit configured to encode a frame image, divided into a number of slices, on a slice basis, decode a number of the encoded slices in order to use the frame image as a reference frame image, and deblock-filter a number of the decoded slices except boundary portions between the decoded slices and a slice edge deblock filter unit configured to comprise a number of slice edge deblock filters operated in conjunction with the encoding unit and to in parallel deblock-filter the boundary portions between the decoded slices using a number of the slice edge deblock filters.

Each of the slice edge deblock filters may be provided in response to at least two neighbor slices of a number of the decoded slices and be configured to deblock-filter a boundary portion between the at least two neighbor slices.

Each of the slice edge deblock filters may be provided in response to at least two neighbor slices of a number of the decoded slices and be configured to determine whether the encoding unit has completed the deblock filtering for the two slices based on specific information received the encoding unit and to deblock-filter a boundary portion between the two slices if, as a result of the determination, the deblock filtering for the two slices is determined to have been completed.

The encoding unit may comprise a number of encoders provided in response to a number of the slices. Each of the slice edge deblock filters may operate in conjunction with at least two of a number of the encoders, corresponding to at least two neighbor slices of a number of the slices, and deblock-filter a boundary portion between the at least two slices respectively decoded by the at least two encoders.

Each of the encoders may operate in conjunction with at least one of the slice edge deblock filters. After the deblock filtering for a corresponding slice is completed, each of the encoders may send information, informing that the deblock filtering for the corresponding slice has been completed, to the at least one slice edge deblock filter.

Each of the slice edge deblock filters may receive pieces of information, informing that the deblock filtering for the at least two slices has been completed, from at least two neighboring encoders of a number of the encoders, load data of a boundary portion between the at least two slices from a frame buffer based on the received information, and deblock-filter the loaded data. Meanwhile, each of the slice edge deblock filters may deblock-filter a boundary portion between neighbor slices of a number of the slices and send deblock-filtered data to a frame buffer.

To achieve the above object, further yet another aspect of the present invention provides a video data processing method. The video data processing method comprises receiving a frame image divided into a number of slices and encoding the received frame image on a slice basis, decoding a number of the encoded slices in order to use the frame image in encoding another frame, deblock-filtering a number of the decoded slices except boundary portions between the decoded slices, and in parallel deblock-filtering the boundary portions between a number of the decoded slices using a number of slice edge deblock filters.

In parallel deblock-filtering the boundary portions between a number of the decoded slices using a number of slice edge deblock filters may comprise, using each of the slice edge deblock filters, determining whether the deblock filtering for two neighbor slices of a number of the decoded slices has been completed and if, as a result of the determination, the deblock filtering for the two neighbor slices is determined to have been completed, deblock-filtering a boundary portion between the two neighbor slices using a corresponding slice edge deblock filter.

### Advantageous Effects of Invention

As described above, according to the embodiments of the present invention, when a frame image divided into a number of slices and then encoded is decoded, the slices are decoded using respective decoders and deblock filtering processing is then performed on the decoded slices except only the boundary portions between the decoded slices. Next, the boundary portions on which deblock filtering processing has not been performed are deblock-filtered in real time and in parallel using a number of slice edge deblock filters. Accordingly, there are advantages in that the picture quality of a frame image can be improved through deblock filtering for the boundary portions between the slices, and also the time that it takes to perform deblock filtering can be reduced and processor resources can be efficiently used.

### BRIEF DESCRIPTION OF DRAWINGS

FIG. 1 is a block diagram showing the construction of a video data processing apparatus according to a first exemplary embodiment of the present invention;

FIG. 2 is a detailed block diagram showing the construction of a decoding unit and a slice edge deblock filter unit shown in FIG. 1

FIG. 3 is a detailed block diagram showing the construction of one of decoders shown in FIG. 2;

FIG. 4 is a block diagram showing the construction of a video data processing apparatus according to a second exemplary embodiment of the present invention;

FIG. 5 is an exemplary diagram illustrating an encoded frame image, inputted to the video data processing apparatus shown in FIG. 4 and divided into slices;

FIG. 6 is a flowchart illustrating the operation of the video data processing apparatus shown in FIG. 4;

FIG. 7 is an exemplary diagram illustrating the boundary portions between slices deblock-filtered by a slice edge deblock filter;

FIG. 8 is a flowchart illustrating an operation of the slice edge deblock filter;

FIG. 9 is a block diagram showing the construction of a video data processing apparatus according to a third exemplary embodiment of the present invention;

FIG. 10 is a detailed block diagram showing the construction of an encoding unit and a slice edge deblock filter unit shown in FIG. 9;

FIG. 11 is a detailed block diagram showing the construction of one of encoders shown in FIG. 10; and

FIG. 12 is a flowchart illustrating an operation of the video data processing apparatus shown in FIG. 10.

### DESCRIPTION OF REFERENCE NUMERALS OF PRINCIPAL ELEMENTS IN THE DRAWINGS

[40] 10: video data processing apparatus

[41] 20: decoding unit

[42] 30: slice edge deblock filter unit

[43] 40: frame buffer

[44] D1, D2 to Dn: decoder

[45] SE1, SE2 to SEn-1: slice edge deblock filter

### Mode for the Invention

Preferred embodiments of the present invention will be described in detail below with reference to the accompanying drawings so that those skilled in the art can easily implement the present invention. In the preferred embodiments of the present invention, specific technical terminologies are used for the clarity of the contents. It is to be understood, however, that the present invention is not limited to the specific terminologies and each specific terminology includes all technical synonyms operating in a similar way in order to accomplish similar objects.

### Embodiment 1

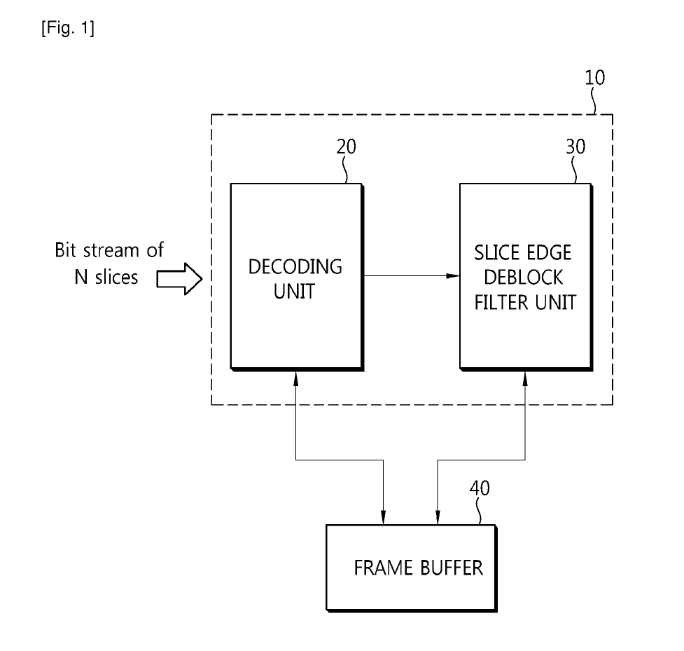

FIG. 1 is a block diagram showing the construction of a video data processing apparatus according to a first exemplary embodiment of the present invention.

Referring to FIG. 1, the video data apparatus 10 according to the first exemplary embodiment of the present invention can include a decoding unit 20 and a slice edge deblock filter unit 30. The decoding unit 20 and the slice edge deblock filter unit 30 can be operated in conjunction with a frame buffer 40. The frame buffer 40 can refer to a storage device for storing video data on a frame basis.

The decoding unit 20 can receive the bit stream (e.g., an H.264 bit stream) of an encoded frame image, having a number of slices. The slice can refer to a block which are composed of a number of macro blocks consecutive to each other according to the sequence of encoding and can be independently decoded without reference to other slices within the same frame image. Decoding and deblock filtering for the slices are performed on a macro-block basis.

The decoding unit 20 can decode a number of the encoded slices on a slice basis and then perform deblock filtering for the decoded slices in order to remove a distortion resulting from the blocking phenomenon at the boundary portions between the macro blocks. To deblock-filter the boundary portions between the macro blocks, data of neighbor macro blocks are required. If data of neighbor slices do not exist, such deblock filtering cannot be performed on macro blocks positioned at the edge portions of the slices (i.e., the boundary portions between the slices). Accordingly, when performing the deblock filtering processing on a slice basis, the decoding unit 20 may not perform deblock filtering for macro blocks corresponding to the boundary portions between the slices, but may perform the deblock filtering processing on only the remaining portions. In other words, the decoding unit 20 performs the deblock filtering processing on the remaining portions of the slices except the boundary portions between the slices.

The slice edge deblock filter unit 30 can include a number of slice edge deblock filters. The slice edge deblock filter unit 30 can in parallel deblock-filter the boundary portions between the slices on which processings (i.e., decoding and deblock filtering for the slices except the boundary portions between the slices) have been performed by the decoding unit 20 using the slice edge deblock filters. A detailed construction and operation of the slice edge deblock filter unit 30 is described later.

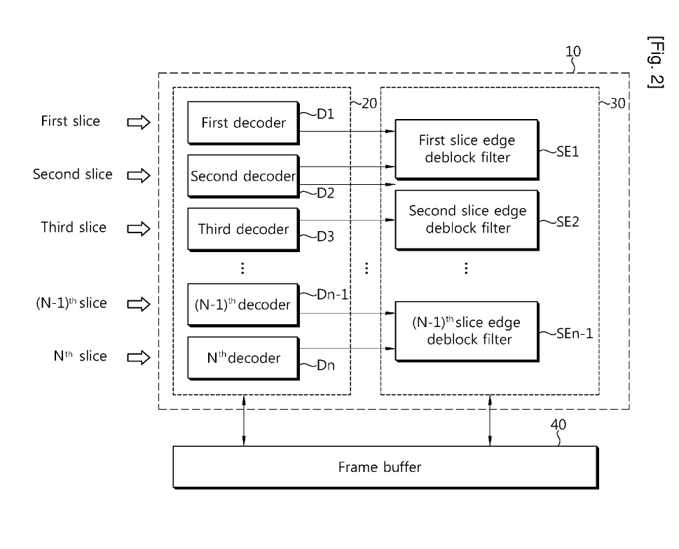

FIG. 2 is a detailed block diagram showing the construction of the decoding unit 20 and the slice edge deblock filter unit 30 shown in FIG. 1. This figure shows an example of the construction of the decoding unit 20 and the slice edge deblock filter unit 30 for processing an N number of encoded slices (where N is an integer greater than 2).

As shown in FIG. 2, the decoding unit 20 can include an N number of decoders respectively corresponding to an N number of the slices. The decoding unit 20 can include, for example, a first decoder D1 to an Nth decoder Dn respectively corresponding to the first slice to the Nth slice. Each of the decoders D1, D2 to Dn can be a core for independently performing an operation function.

Each of the decoders D1, D2 to Dn can receive a corresponding encoded slice, decode the received slice, and then deblock-filter the decoded slice except its edge portions (i.e., the boundary portions between the slices). For example, the first decoder D1 can receive the first slice, decode the received first slice, and deblock-filter the remaining portions of the decoded first slice except the boundary portions between the first slice and the second slice. In a similar way, the second decoder D2 can receive the second slice, decode the received second slice, and deblock-filter the remaining portions of the decoded second slice except the boundary portion between the second slice and the first slice and the boundary portion between the second slice and the third slice.

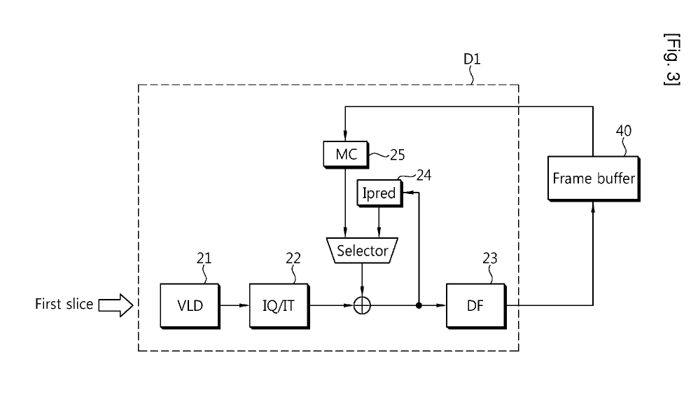

A detailed construction of one of the decoders D1, D2 to Dn included in the decoding unit 20 is shown in FIG. 3. FIG. 3 is a detailed block diagram showing the construction of one (e.g., the first decoder D1) of the first to N^{th} decoders D1, D2 to Dn shown in FIG. 2. The first decoder D1 is described as an example below.

As shown in FIG. 3, the first decoder D1 can include a Variable Length Decoder (VLD) 21, an Inverse Quantization/Inverse Transformer (IQ/IT) 22, an Intra-predictor (Ipred) 24, a Motion Compensator (MC) 25, a Deblock Filter (DF) 23, and so on. The VLD 21 analyzes, operates, and decodes data of the first slice which has been encoded and received. The IQ/IT 22 performs inverse quantization and inverse discrete cosine transform operations on the coefficient values of the macro blocks of the first slice processed by the VLD 21. The intra-predictor 24 performs operations according to an intra-mode on the basis of a current frame image. The MC 25 performs motion prediction and weight prediction operations according to an inter-mode on the basis of a previous frame image. The DF 23 performs deblock filtering for removing a distortion in the picture quality, resulting from the blocking phenomenon at the boundary portions of the macro blocks. When performing the deblock filtering processing on the first slice, the DF 23 may not perform the deblock filtering processing on the boundary portions between the first slide and a neighbor slice (i.e., the second slice), but may perform the deblock filtering processing on the remaining portions of the first slice except the boundary portions between the first slide and the second slice.

The first decoder D1 can have the same construction as a decoder standardized in H.264/AVC, etc. The construction of the first decoder D1 can be applied to the second decoder D2 to the N^{th} decoder Dn in the same manner. It is, however, to be noted that the construction of the decoder shown in FIG. 3 is only one embodiment and, in some implementations, each of the first to N^{th} decoders D1, D2 to Dn included in the decoding unit 20 may be configured in various ways.

Meanwhile, each of the first to Nth decoders D1, D2 to Dn included in the decoding unit 20 can be operated in conjunction with one or more slice edge deblock filters SE1, SE2 to SEn-1. For example, the first decoder D1 can be operated in conjunction with the first slice edge deblock filter SE1, and the second decoder D2 can be operated in conjunction with the first slice edge deblock filter SE1 and the second slice edge deblock filter SE2. According to the same concept, the third decoder D3 can be operated in conjunction with the second slice edge deblock filter SE2 and the third slice edge deblock filter (not shown).

Each of the decoders D1, D2 to Dn can deblock-filter a corresponding slice and then send slice deblock filtering completion information for the corresponding slice to one or more corresponding slice edge deblock filters SE1, SE2 to SEn-1 which are operated in conjunction with the corresponding decoder.

For example, after completing deblock filtering for the first slice, the first decoder D1 can send first slice deblock filtering completion information, informing that the deblock filtering processing for the first slice has been completed, to the first slice edge deblock filter SE1. After completing deblock filtering for the second slice, the second decoder D2 can send second slice deblock filtering completion information, informing that the deblock filtering processing for the second slice has been completed, to the first slice edge deblock filter SE1 and the second slice edge deblock filter SE2. According to the same concept, after completing deblock filtering for the third slice, the third decoder D3 can send third slice deblock filtering completion information, informing that the deblock filtering processing for the third slice has been completed, to the second slice edge deblock filter SE2 and the third slice edge deblock filter (not shown).

The slice deblock filtering completion information, transmitted from each of the decoders D1, D2 to Dn to the one or more corresponding slice edge deblock filters SE1, SE2 to SEn-1 as described above, can be used as basis information which is used to determine a point of time at which the one or more corresponding slice edge deblock filters SE1, SE2 to SEn-1 deblock-filter the boundary portions between the slices.

Meanwhile, the slice edge deblock filter unit 30 can include a number of the slice edge deblock filters SE1, SE2 to SEn-1. As shown in FIG. 2, the slice edge deblock filter unit 30 can include, for example, an (N−1) number of the slice edge deblock filters SE1, SE2 to SEn-1 corresponding to the boundary portions between an N number of the slices. Each of the slice edge deblock filters SE1, SE2 to SEn-1 can be a core for independently performing an operation function.

Each of the slice edge deblock filters SE1, SE2 to SEn-1 can correspond to two neighbor slices of an N number of the slices and can deblock-filter the boundary portions between the two neighbor slices. For example, the first slice edge deblock filter SE1 can correspond to the first slice and the second slice and deblock-filter the boundary portions between the first slice and the second slice. The second slice edge deblock filter SE2 can correspond to the second slice and the third slice and can deblock-filter the boundary portions between the second slice and the third slice. According to the same concept, the (N−1)^{th} slice edge deblock filter SEn-1 can correspond to the (N−1)^{th} slice and the N^{th} slice and can deblock-filter the boundary portions between the (N−1)^{th} slice and the N^{th} slice.

Each of the slice edge deblock filters SE1, SE2 to SEn-1 can be operated in conjunction with two of the decoders D1, D2 to Dn, which decode and deblock-filter two corresponding slices. In other words, each of the slice edge deblock filters SE1, SE2 to SEn-1 can be operated in conjunction with two of the decoders D1, D2 to Dn, which process two corresponding slices. Each of the slice edge deblock filters SE1, SE2 to SEn-1 can determine whether two corresponding slices have been deblock-filtered based on two pieces of slice deblock filtering completion information received from two corresponding decoders of the decoders D1, D2 to Dn. If, as a result of the determination, the two corresponding slices are determined to have been deblock-filtered, the corresponding one of the slice edge deblock filters SE1, SE2 to SEn-1 can deblock-filter the remaining portions of the two corresponding slices (i.e., the boundary portions between the two corresponding slices) which have not yet been deblock-filtered.

For example, the first slice edge deblock filter SE1 can check whether two pieces of slice deblock filtering completion information have been received from the first decoder D1 and the second decoder D2, determine that deblock filtering for the first slice and the second slice has been completed if the two pieces of slice deblock filtering completion information have been received from the first decoder D1 and the second decoder D2, and deblock-filter the boundary portions between the first slice and the second slice.

The construction of the video data processing apparatus according to the first exemplary embodiment of the present invention has been described above. As described above, the video data processing apparatus according to the first exemplary embodiment decodes encoded slices using respective decoders and performs deblock filtering for the encoded slices except only the boundary portions between the encoded slices. Further, the video data processing apparatus deblock-filters the boundary portions between the slices, which have not been deblock-filtered, using a number of the slice edge deblock filters in real time and in parallel. Accordingly, the quality of picture can be improved by performing deblock filtering on the boundary portions between the slices, and also the time that it takes to perform deblock filtering can be reduced and processor resources can be efficiently used.

### Embodiment 2

Hereinafter, a video data processing apparatus for processing a frame image divided into five slices according to a second exemplary embodiment of the present invention is described and, from a viewpoint of methodology, the present invention is described through the operation of the video data processing apparatus.

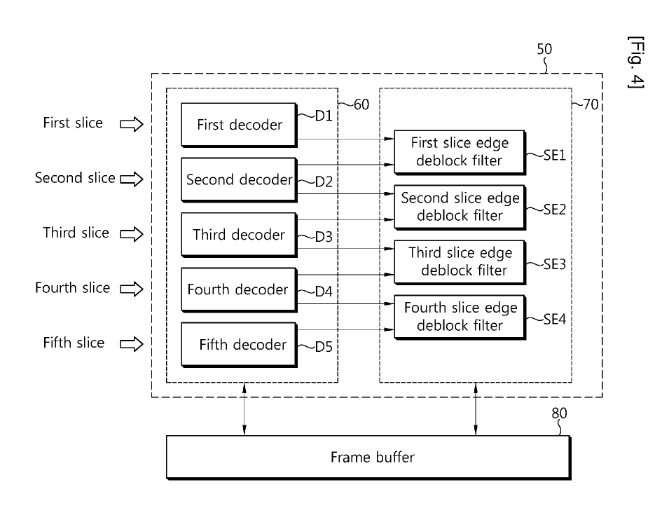

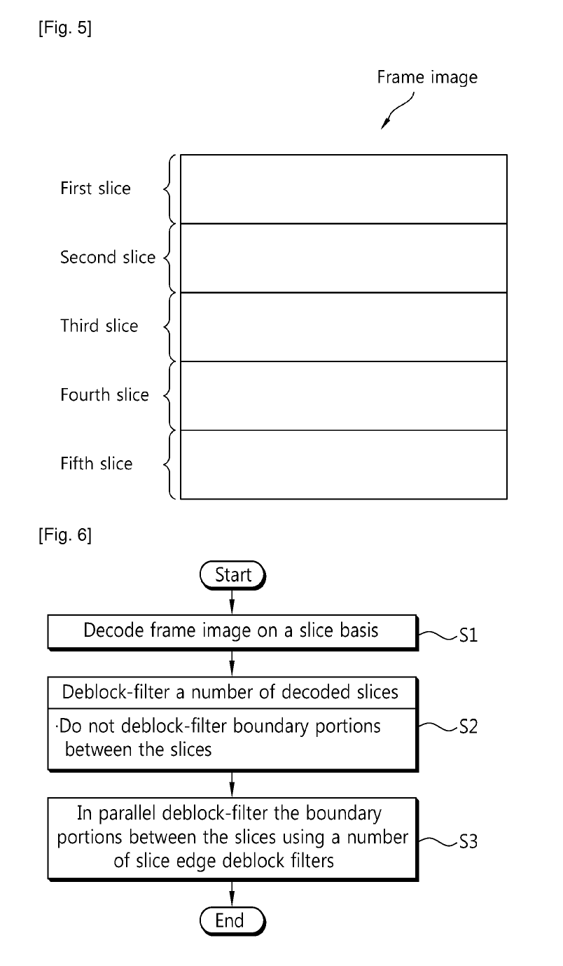

FIG. 4 is a block diagram showing the construction of the video data processing apparatus according to the second exemplary embodiment of the present invention. FIG. 5 is an exemplary diagram illustrating an encoded frame image, inputted to the video data processing apparatus shown in FIG. 4 and divided into slices.

As shown in FIG. 4, the video data processing apparatus 50 can receive an encoded frame image divided into five slices (e.g., a first slice, a second slice, a third slice, a fourth slice, and a fifth slice). It is assumed that the five slices, as shown in FIG. 5, are results of horizontally dividing the frame image into five blocks. The slice can refer to a block which are composed of a number of macro blocks consecutive to each other according to the sequence of encoding and can be independently decoded without reference to other slices within the same frame image. Meanwhile, it is to be noted that the division of the slices shown in FIG. 5 is only one embodiment, and the slices may be divided in various ways in some implementations.

Referring to FIG. 4, the video data processing apparatus 50 can include a decoding unit 60 and a slice edge deblock filter unit 70. The decoding unit 60 and the slice edge deblock filter unit 70 can be operated in conjunction with a frame buffer 80.

The decoding unit 60 can include five decoders D1 to D5 (i.e., a first decoder D1, a second decoder D2, a third decoder D3, a fourth decoder D4, and a fifth decoder D5) respectively corresponding to five slices (i.e., a first slice, a second slice, a third slice, a fourth slice, and a fifth slice).

The slice edge deblock filter unit 70 can include four slice edge deblock filters SE1 to SE4 for deblock-filtering the boundary portions between the five slices. For example, the first slice edge deblock filter SE1 can deblock-filter the boundary portions between the first slice and the second slice and can be operated in conjunction with the first decoder D1 and the second decoder D2. The second slice edge deblock filter SE2 can deblock-filter the boundary portions between the second slice and the third slice and can be operated in conjunction with the second decoder D2 and the third decoder D3. The third slice edge deblock filter SE3 can deblock-filter the boundary portions between the third slice and the fourth slice and can be operated in conjunction with the third decoder D3 and the fourth decoder D4. According to the same concept, the fourth slice edge deblock filter SE4 can deblock-filter the boundary portions between the fourth slice and the fifth slices and can be operated in conjunction with the fourth decoder D4 and the fifth decoder D5.

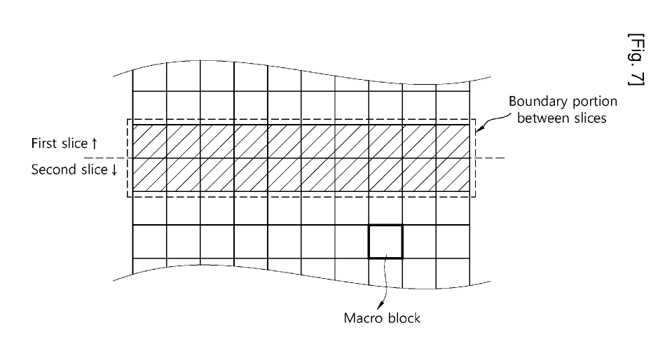

FIG. 6 is a flowchart illustrating the operation of the video data processing apparatus 50 shown in FIG. 4.

Referring to FIG. 6, the video data processing apparatus 50 receives a frame image which has been divided into a number of slices and encoded, decodes the received frame image on a slice basis using the decoders D1 to D5 at step S1, and deblock-filters a number of the decoded slices except the boundary portions between the slices at step S2. In other words, a number of the slices are processed in parallel using a number of the decoders D1 to D5. After completing processings (i.e., decoding a corresponding slice and deblock filtering for the remaining portions except the boundary portions between the slices) for the corresponding slice, each of the decoders D1 to D5 can send information, indicating the completion of the processings, to one or more of the slice edge deblock filters SE1 to SE4 which are operated in conjunction with the corresponding decoder.

For example, the first decoder D1 can decode the encoded first slice and deblock-filter the decoded first slice except the boundary portions between the first slice and the second slice. Next, the first decoder D1 can store the processed first slice in the frame buffer 80 and send first slice deblock filtering completion information to a corresponding slice edge deblock filter (i.e., the first slice edge deblock filter SE1) which is operated in conjunction with the first decoder D1.

The second decoder D2 can decode the encoded second slice and deblock-filter the decoded second slice except the boundary portion between the second slice and the first slice and the boundary portion between the second slice and the third slice. Next, the second decoder D2 can store the processed second slice in the frame buffer 80 and send second slice deblock filtering completion information to one or more corresponding slice edge deblock filters (i.e., the first slice edge deblock filter SE1 and the second slice edge deblock filter SE2) which are operated in conjunction with the second decoder D2.

The third decoder D3 can decode the encoded third slice and deblock-filter the decoded third slice except the boundary portion between the third slice and the second slice and the boundary portion between the third slice and the fourth slice. Next, the third decoder D3 can store the processed third slice in the frame buffer 80 and send third slice deblock filtering completion information to one or more corresponding slice edge deblock filters (i.e., the second slice edge deblock filter SE2 and the third slice edge deblock filter SE3) which are operated in conjunction with the third decoder D3.

The fourth decoder D4 can decode the encoded fourth slice and deblock-filter the decoded fourth slice except the boundary portion between the fourth slice and the third slice and the boundary portion between the fourth slice and the fifth slice. Next, the fourth decoder D4 can store the processed fourth slice in the frame buffer 80 and send fourth slice deblock filtering completion information to one or more corresponding slice edge deblock filters (i.e., the third slice edge deblock filter SE3 and the fourth slice edge deblock filter SE4) which are operated in conjunction with the fourth decoder D4.

The fifth decoder D5 can decode the encoded fifth slice and deblock-filter the decoded fifth slice except the boundary portions between the fifth slice and the fourth slice. Next, the fifth decoder D5 can store the processed fifth slice in the frame buffer 80 and send fifth slice deblock filtering completion information to a corresponding slice edge deblock filter (i.e., the fourth slice edge deblock filter SE4) which is operated in conjunction with the fifth decoder D5.

Next, the video data processing apparatus 50 in parallel deblock-filters the boundary portions between the slices, not deblock-filtered by the decoding unit 60, using a number of the slice edge deblock filters SE1 to SE5 at step S3. For example, the first slice edge deblock filter SE1 can deblock-filter the boundary portions between the first slice and the second slice. According to the same concept, the second slice edge deblock filter SE2 can deblock-filter the boundary portions between the second slice and the third slice. The third slice edge deblock filter SE3 can deblock-filter the boundary portions between the third slice and the fourth slice. The fourth slice edge deblock filter SE4 can deblock-filter the boundary portions between the fourth slice and the fifth slice.

FIG. 7 is an exemplary diagram illustrating the boundary portions between the slices deblock-filtered by the slice edge deblock filter. The boundary portion between the first slice and the second slice is shown as an example.

As shown in FIG. 7, neighbor portions between first and second different slices can refer to the macro blocks of portions where the first and second slices come in contact with each other. In the example of FIG. 7, the boundary portion between the first slice and the second slice can refer to the last row of the macro blocks in the first slice and the first row of the macro blocks in the second slice.

Each of the slice edge deblock filters SE1 to SE4 can determine whether the two neighbor slices have been deblock-filtered by two of the decoders D1 to D5 and deblock-filter the boundary portion between the two neighbor slices if the deblock filtering processing has been completed.

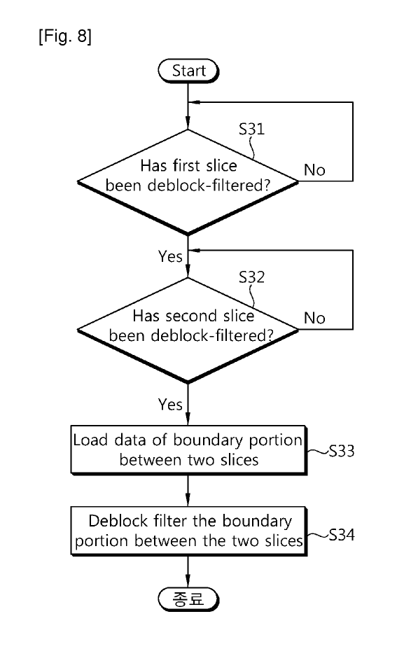

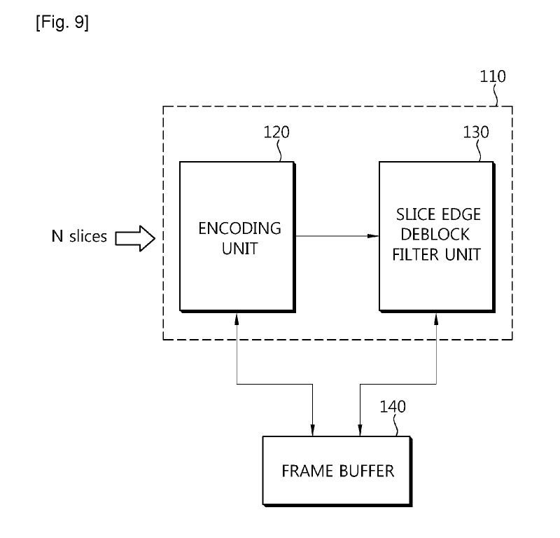

FIG. 8 is a flowchart illustrating an operation of each of the slice edge deblock filters SE1 to SE4. The operation of one (e.g., the first slice edge deblock filter SE1) of the slice edge deblock filters SE1 to SE4 included in the slice edge deblock filter unit 70 is described an example below.

Referring to FIG. 8, the first slice edge deblock filter SE1 can determine whether the first slice has been deblock-filtered at step S31. Such determination can be made based on specific information received from the decoding unit 60. For example, the first slice edge deblock filter SE1 can determine whether the first slice has been deblock-filtered based on the first slice deblock filtering completion information received from the first decoder D1.

If, as a result of the determination, the first slice is determined to have been deblock-filtered, the first slice edge deblock filter SE1 can determine whether the second slice has been deblock-filtered at step S32. For example, the first slice edge deblock filter SE1 can determine whether the second slice has been deblock-filtered based on the second slice deblock filtering completion information received from the second decoder D2.

Although each of the slice edge deblock filters can determine whether one or more corresponding slice have been deblock-filtered based on information received from one or more corresponding decoders, the present invention is not limited thereto, but, in some implementations, may be properly implemented. For example, the slice edge deblock filter may actively request information from the decoder or the frame buffer 80. In some embodiments, a specific control module for overall controlling the decoding unit 60 may monitor whether a specific slice has been deblock-filtered and send deblock filtering completion information about the corresponding slice to a corresponding slice edge deblock filter.

Meanwhile, it has been described that the first slice edge deblock filter SE1 first determines whether the first slice has been deblock-filtered and then determines whether the second slice has been deblock-filtered. However, the first slice edge deblock filter SE1 may first determine whether the second slice has been deblock-filtered and then determine whether the first slice has been deblock-filtered.

If it is determined that the first slice and the second slice have been deblock-filtered by the first decoder D1 and the second decoder D2, respectively, the first slice edge deblock filter SE1 can load data of the boundary portion between the first slice and the second slice from the frame buffer 80 at step S33 and deblock-filter the boundary portion between the two slices at step S34.

Each of the second slice edge deblock filter SE2 to the fifth slice edge deblock filter SE5 performs the same process for two corresponding slices, which has been performed by the first slice edge deblock filter SE1.

In other words, each of the first to fifth slice edge deblock filters SE1 to SE5 deblock-filters the boundary portion between corresponding slices in real time and independently. Accordingly, the slice edge deblock filter unit 70 can in parallel deblock-filter the boundary portions between the five slices.

For example, it is assumed that the processing sequence (i.e., decoding and deblock filtering except slice boundary portions) of the decoders D1 to D5 is the first slice, the third slice, the fifth slice, the fourth slice, and the second slice.

After the first, third, and fifth slices are respectively processed by the first decoder D1, the third decoder D3, and the fifth decoder D5, at a point of time at which processing for the fourth slice is completed by the fourth decoder D4, the third slice edge deblock filter SE3 and the fourth slice edge deblock filter SE4 start deblock-filtering the boundary portion between the third slice and the fourth slice and the boundary portion between the fourth slice and the fifth slice, respectively. Next, at a point of time at which processing for the second slice is completed by the second decoder SE2, the first slice edge deblock filter SE1 and the second slice edge deblock filter SE2 start deblock-filtering the boundary portion between the first slice and the second slice and the boundary portion between the second slice and the third slice, respectively. If the third slice edge deblock filter SE3 and the fourth slice edge deblock filter SE4 have not deblock-filtered the boundary portions between the corresponding slices, all the four slice edge deblock filters SE1 to SE4 may be operated at the same time.

As described above, according to the second embodiment of the present invention, when a frame image divided into a number of slices and then encoded is decoded, the slices are decoded using respective decoders, and deblock filtering is performed except only the boundary portions between a corresponding slice and another slice. The boundary portions between the slices which have not been deblock-filtered are deblock-filtered using a number of the slice edge deblock filters in real time and in parallel. Accordingly, the quality of picture can be improved by performing deblock filtering for the boundary portions between the slices, and also the time that it takes to perform deblock filtering can be reduced and processor resources can be efficiently used.

### Embodiment 3

Typically, a video encoder for encoding video data performs a process of encoding external video data and decoding the encoded data in order to use the encoded data as the reference frame of another frame. Accordingly, since the video encoder requires deblock filtering for removing deterioration of the quality of picture, the construction of the video data processing apparatus can also be applied to the video encoder. Hereinafter, a video data processing apparatus according to a third exemplary embodiment of the present invention is described.

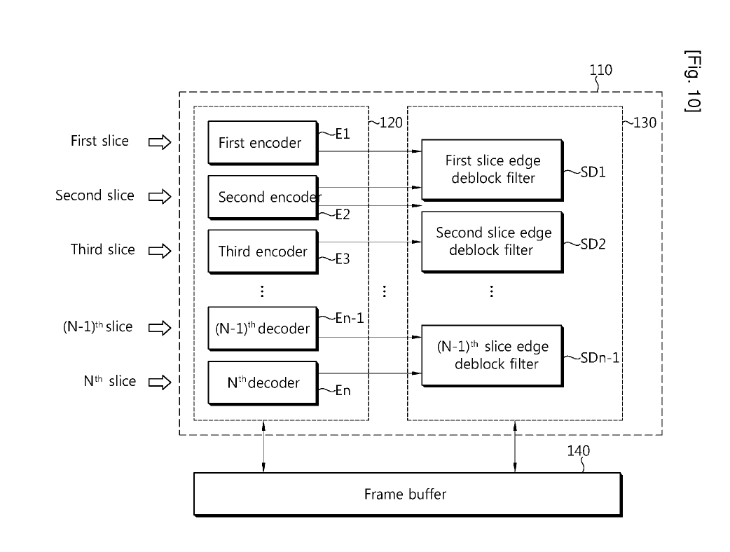

FIG. 9 is a block diagram showing the construction of the video data processing apparatus according to the third exemplary embodiment of the present invention.

As shown in FIG. 9, the video data processing apparatus 110 according to the third exemplary embodiment of the present invention can include an encoding unit 120 and a slice edge deblock filter unit 130. The encoding unit 120 and the slice edge deblock filter unit 130 can be operated in conjunction with a frame buffer 140. The frame buffer 140 can refer to a storage device for storing video data on a frame basis.

The encoding unit 120 receives a frame image divided into a number of slices, encodes the received slices on a slice basis, decodes a number of the encoded slices in order to use the encoded image when encoding another frame, and deblock-filters a number of the decoded slices except the boundary portions between the slices. The encoding, decoding, and deblock filtering for each slice are performed for every predetermined block (e.g., on a macro-block basis).

The slice edge deblock filter unit 130 can include a number of slice edge deblock filters. The slice edge deblock filter unit 130 can in parallel deblock-filter the boundary portions between a number of slices, processed by the encoding unit 120, using a number of the slice edge deblock filters.

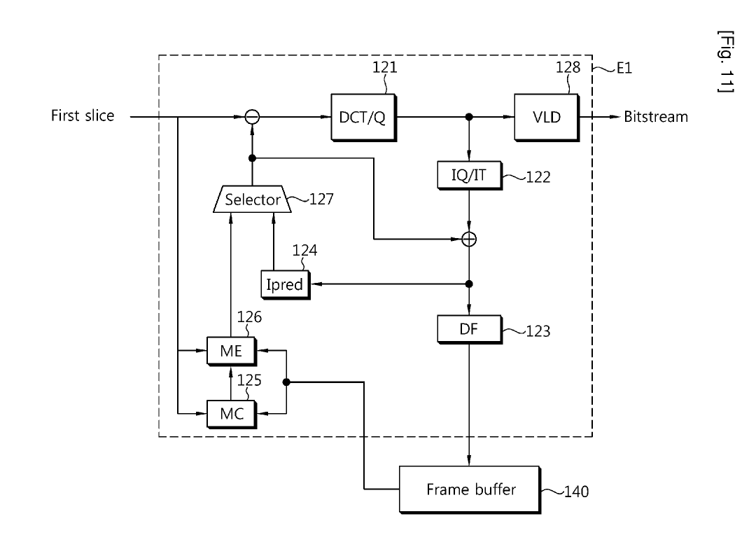

FIG. 10 is a detailed block diagram showing the construction of the encoding unit 120 and the slice edge deblock filter unit 130 shown in FIG. 9. This figure shows an example of the construction of the encoding unit 120 and the slice edge deblock filter unit 130 for processing an N number of slices (where N is an integer greater than 2).

As shown in FIG. 10, the encoding unit 120 can include, for example, an N number of encoders E1, E2 to En respectively corresponding to an N number of the slices. For example, the first encoder E1 to the N^{th} encoder En can correspond to the first slice to the N^{th} slice, respectively. Each of the encoders E1, E2 to En can be a core for independently performing an operation function.

Each of the encoders E1, E2 to En can receive a corresponding slice, encode the received slice, decode the encoded slice, and deblock-filter the decoded slice except the edge portions of the decoded slice (i.e., the boundary portion between the corresponding slice and other slices). For example, the first encoder E1 can receive the first slice, encode the received first slice, decode the encoded first slice, and deblock-filter the remaining portions of the decoded first slice except the boundary portion between the decoded first slice and the second slice. In a similar way, the second encoder E2 can receive the second slice, encode the received second slice, decode the encoded second slice, and deblock-filter the remaining portions of the decoded second slice except the boundary portion between the decoded second slice and the first slice and the boundary portion between the decoded second slice and the third slice.

A detailed construction of one of the encoders E1, E2 to En is shown in FIG. 11. FIG. 11 is a detailed block diagram showing the construction of one (e.g., the first encoder E1) of the encoders E1, E2 to En shown in FIG. 10. The construction of the first encoder E1 of an N number of the encoders E1, E2 to En included in the encoding unit 120 is described as an example below.

As shown in FIG. 11, the first encoder E1 includes a Discrete Cosine Transform/Quantization (DCT/Q) unit 121, a Variable Length Coder (VLC) 128, an Inverse Quantization/Inverse Transformer (IQ/IT) 122, an Intra-predictor (Ipred) 124, a Motion Compensator (MC) 125, a Motion Estimator (ME) 126, a selector 127, and a Deblock Filter (DF) 123. The DCT/Q unit 121 performs discrete cosine transform and quantization for a difference signal between current and reference frame images in order to encode the first slice. The VLC 128 performs entropy coding for the data, processed by the DCT/Q unit 121, in order to send the data externally. The IQ/IT 122 performs inverse quantization and inverse discrete cosine transform for the data, processed by the DCT/Q unit 121, in order to decode the data. The intra-predictor 124 performs operations according to an intra-mode based on the current frame image. The MC 125 performs motion prediction and weight prediction operations according to an inter-mode based on the reference frame image. The selector 127 selects intra- or inter-prediction. The DF 123 performs deblock filtering for removing a distortion in the quality of picture resulting from the blocking phenomenon at the boundary portions of macro blocks. The DF 123 may not perform deblock filtering for the boundary portion between the first slice and a neighbor slice (i.e., the second slice), but may perform deblock filtering for the remaining portions of the first slice.

The first encoder E1 can have the same construction as an encoder standardized in H.264/AVC, etc. The construction of the first encoder E1 can be applied to the second encoder E2 to the N^{th} encoder En in the same manner. It is, however, to be noted that the construction of the encoder E1 shown in FIG. 11 is only one embodiment and, in some implementations, each of the first to N^{th} encoders E1, E2 to En included in the encoding unit 120 may be configured in various ways.

Each of the encoders E1, E2 to En included in the encoding unit 120 can be operated in conjunction with at least one of the slice edge deblock filters SD1, SD2 to SDn-1. For example, the first encoder E1 can be operated in conjunction with the first slice edge deblock filter SD1. The second encoder E2 can be operated in conjunction with the first slice edge deblock filter SD1 and the second slice edge deblock filter SD2. According to the same concept, the third encoder E3 can be operated in conjunction with the second slice edge deblock filter SD2 and the third slice edge deblock filter SD3.

Each of the encoders E1, E2 to En can deblock-filter a corresponding slice and then send slice deblock filtering completion information, informing that the deblock filtering for the corresponding slice has been completed, to the one or more slice edge deblock filters SD1, SD2 to SDn-1 which are operated in conjunction with the corresponding encoder.

For example, the first encoder E1 can send first slice deblock filtering completion information, informing that deblock filtering for the first slice has been completed, to the first slice edge deblock filters SD1 after the deblock filtering for the first slice. The second encoder E2 can send second slice deblock filtering completion information, informing that deblock filtering for the second slice has been completed, to the first slice edge deblock filter SD1 and the second slice edge deblock filter SD2 after the deblock filtering for the second slice. According to the same concept, the third encoder E3 can send third slice deblock filtering completion information, informing that deblock filtering for the third slice has been completed, to the second slice edge deblock filter SD2 and the third slice edge deblock filter SD3 after the deblock filtering for the third slice.

The slice deblock filtering completion information, transmitted from each of the encoders E1, E2 to En to the one or more corresponding slice edge deblock filters SD1, SD2 to SDn-1 as described above, can be used as basis information which is used to determine a point of time at which the one or more corresponding slice edge deblock filters SD1, SD2 to SDn-1 deblock-filter the boundary portions between the slices.

Meanwhile, the slice edge deblock filter unit 130 can include a number of the slice edge deblock filters SD1, SD2 to SDn-1. For example, the slice edge deblock filter unit 130 can include, as shown in FIG. 10, an (N−1) number of the slice edge deblock filters SD1, SD2 to SDn-1 respectively corresponding to the boundary portions between an N number of the slices. Each of the slice edge deblock filters SD1, SD2 to SDn-1 can be a core for independently performing an operation function.

Each of the slice edge deblock filters SD1, SD2 to SDn-1 is provided in response to two neighbor slices of the first to N^{th} slices and can deblock-filter the boundary portion between the two corresponding slices. For example, the first slice edge deblock filter SD1 can correspond to the first slice and the second slice of the first to N^{th} slices and deblock-filter the boundary portion between the first slice and the second slice. The second slice edge deblock filter SD2 can correspond to the second slice and the third slice of the first to N^{th} slices and deblock-filter the boundary portion between the second slice and the third slice. According to the same concept, the (N−1)^{th} slice edge deblock filter Sn-1 can correspond to the (N−1)^{th} slice and the N^{th} slice of the first to N^{th} slices and deblock-filter the boundary portion between the (N−1)^{th} slice and the N^{th} slice.

Each of the slice edge deblock filters SD1, SD2 to SDn-1 can be operated in conjunction with two corresponding ones of the encoders E1, E2 to En. In other words, each of the slice edge deblock filters SD1, SD2 to SDn-1 can be operated in conjunction with two corresponding ones of the encoders E1, E2 to En, which process respective slices. Each of the slice edge deblock filters SD1, SD2 to SDn-1 can determine whether two corresponding slices have been deblock-filtered based on two pieces of the slice deblock filtering completion information received from two corresponding ones of the encoders E1, E2 to En and, after the two corresponding slices have been deblock-filtered, deblock-filter the remaining portions of the two corresponding slices which have not yet been deblock-filtered (i.e., the boundary portion between the two corresponding slices).

For example, the first slice edge deblock filter SD1 can check whether two pieces of slice deblock filtering completion information have been received from the first encoder E1 and the second encoder E2, determine that deblock filtering for the first and second slices has been completed if, as a result of the check, the two pieces of slice deblock filtering completion information have been received from the first encoder E1 and the second encoder E2, and deblock-filter the boundary portion between the first slice and the second slice.

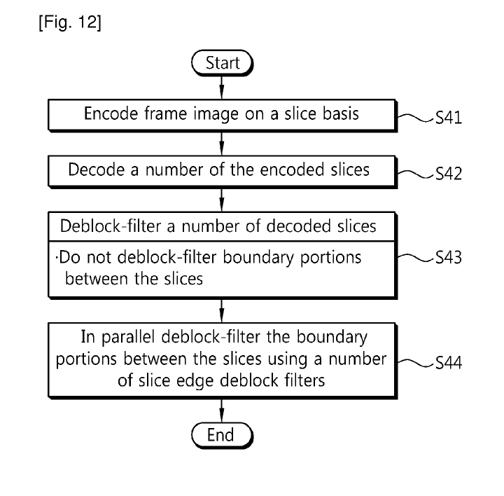

FIG. 12 is a flowchart illustrating an operation of the video data processing apparatus shown in FIG. 10.

Referring to FIG. 12, the video data processing apparatus 110 receives a frame image divided into a number of the slices, encodes the slices on a slice basis using a number of the respective encoders E1, E2 to En at step S41, and decodes the encoded slices on a slice basis in order to use the encoded image as a reference image at step S42. The video data processing apparatus 110 deblock-filters the decoded slices on a slice basis except the boundary portions between the decoded slices at step S43. In this case, after the deblock filtering for a corresponding slice has been completed, each of the encoders E1, E2 to En may store the data of the corresponding slice in the frame buffer 140 and also send slice deblock filtering completion information, informing that the deblock filtering for the corresponding slice has been completed, to one or more of the slice edge deblock filters SD1, SD2 to SDn-1.

Next, the video data processing apparatus 110 in parallel deblock-filters the boundary portions between a number of the decoded slices using a number of the slice edge deblock filters SD1, SD2 to SDn-1 at step S44. Here, each of the slice edge deblock filters SD1, SD2 to SDn-1 can determine whether deblock filtering for two corresponding slices has been completed, load the data of the boundary portion between the two corresponding slices from the frame buffer 140 if, as a result of the determination, the deblock filtering for the two corresponding slices is determined to have been completed, and perform the deblock filtering processing.

Meanwhile, in the video data processing apparatuses according to the first to third embodiments, each of the slice edge deblock filters included in the slice edge deblock filter unit is illustrated to correspond to the boundary portion of two slices (i.e., one boundary portion). However, in some embodiments, the slice edge deblock filter unit may include a number of the slice edge deblock filters, and each of the slice edge deblock filters may deblock-filter a number of the boundary portions.

For example, in a fourth embodiment, in order to deblock-filter the boundary portions between five slices (e.g., a first slice, a second slice, a third slice, a fourth slice, and a fifth slice), the slice edge deblock filter unit may include two slice edge deblock filters (e.g., a first slice edge deblock filter and a second slice edge deblock filter).

In this case, the first slice edge deblock filter may be configured to deblock-filter the boundary portion between the first slice and the second slice and the boundary portion between the second slice and the third slice. Further, the second slice edge deblock filter may be configured to deblock-filter the boundary portion between the third slice and the fourth slice and the boundary portion between the fourth slice and the fifth slice.

For example, in a fifth embodiment, the slice edge deblock-filter may have a different number of the boundary portions between slices on which deblock filtering is performed. For example, a high operation processing capacity can be assigned to a slice edge deblock filter having a good processing performance and a low operation processing capacity can be assigned to a slice edge deblock filter having a poor processing performance, depending on the processing performance of the slice edge deblock filter.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A video data processing apparatus, comprising:
a decoding unit configured to decode a frame image, divided into a number of slices and then encoded, on a slice basis and to deblock-filter a number of the decoded slices except boundary portions between the decoded slices; and
a slice edge deblock filter unit configured to comprise a number of slice edge deblock filters operated in conjunction with the decoding unit and to in parallel deblock-filter the boundary portions between the decoded slices using a number of the slice edge deblock filters.

2. The video data processing apparatus of claim 1, wherein each of the slice edge deblock filters corresponds to at least two neighbor slices of a number of the decoded slices and is configured to deblock-filter a boundary portion between the at least two neighbor slices.

3. The video data processing apparatus of claim 1, wherein each of the slice edge deblock filters corresponds to two neighbor slices of a number of the decoded slices and is configured to determine whether the decoding unit has completed the deblock filtering for the two neighbor slices based on information received the decoding unit and to deblock-filter a boundary portion between the two neighbor slices if, as a result of the determination, the deblock filtering for the two neighbor slices is determined to have been completed.

4. The video data processing apparatus of claim 1, wherein the decoding unit comprises a number of decoders corresponding to a number of the slices.

5. The video data processing apparatus of claim 4, wherein each of the slice edge deblock filters operates in conjunction with at least two of a number of the decoders, corresponding to at least two neighbor slices of a number of the slices, and deblock-filters a boundary portion between the at least two slices respectively decoded and deblock-filtered by the at least two decoders.

6. The video data processing apparatus of claim 4, wherein each of the decoders operates in conjunction with at least one of the slice edge deblock filters and, after the deblock filtering for a corresponding slice is completed, sends information, informing that the deblock filtering for the corresponding slice has been completed, to the at least one slice edge deblock filter.

7. The video data processing apparatus of claim 6, wherein each of the slice edge deblock filters receives pieces of information, informing that the deblock filtering for the at least two slices has been completed, from at least two neighbor decoders of a number of the decoders, loads data of a boundary portion between the at least two slices from a frame buffer based on the received information, and deblock-filters the loaded data.

8. The video data processing apparatus of claim 1, wherein each of the slice edge deblock filters deblock-filters a boundary portion between neighbor slices of a number of the slices and sends deblock-filtered data to a frame buffer.

9. A video data processing method, comprising:
decoding a frame image, divided into a number of slices and then encoded, on a slice basis;
deblock-filtering a number of the decoded slices except boundary portions between the decoded slices; and
in parallel deblock-filtering the boundary portions between a number of the decoded slices using a number of slice edge deblock filters.

10. The video data processing method of claim 9, wherein in parallel deblock-filtering the boundary portions between a number of the decoded slices using a number of slice edge deblock filters comprises, using each of the slice edge deblock filters:
determining whether the deblock filtering for two neighbor slices of a number of the decoded slices has been completed; and
if, as a result of the determination, the deblock filtering for the two neighbor slices is determined to have been completed, deblock-filtering a boundary portion between the two neighbor slices using a corresponding slice edge deblock filter.

11. A video data processing apparatus, comprising:
an encoding unit configured to encode a frame image, divided into a number of slices, on a slice basis, decode a number of the encoded slices in order to use the frame image as a reference frame image, and deblock-filter a number of the decoded slices except boundary portions between the decoded slices; and
a slice edge deblock filter unit configured to comprise a number of slice edge deblock filters operated in conjunction with the encoding unit and to in parallel deblock-filter the boundary portions between the decoded slices using a number of the slice edge deblock filters.

12. The video data processing apparatus of claim 11, wherein each of the slice edge deblock filters corresponds to at least two neighbor slices of a number of the decoded slices and is configured to deblock-filter a boundary portion between the at least two neighbor slices.

13. The video data processing apparatus of claim 11, wherein each of the slice edge deblock filters corresponds to two neighbor slices of a number of the decoded slices and is configured to determine whether the encoding unit has completed the deblock filtering for the two neighbor slices based on specific information received the encoding unit and to deblock-filter a boundary portion between the two neighbor slices if, as a result of the determination, the deblock filtering for the two neighbor slices is determined to have been completed.

14. The video data processing apparatus of claim 11, wherein the encoding unit comprises a number of encoders corresponding to a number of the slices.

15. The video data processing apparatus of claim 14, wherein each of the slice edge deblock filters operates in conjunction with at least two of a number of the encoders, corresponding to at least two neighbor slices of a number of the slices, and deblock-filters a boundary portion between the at least two slices respectively decoded by the at least two encoders.

16. The video data processing apparatus of claim 14, wherein each of the encoders operates in conjunction with at least one of the slice edge deblock filters and, after the deblock filtering for a corresponding slice is completed, sends information, informing that the deblock filtering for the corresponding slice has been completed, to the at least one slice edge deblock filter.

17. The video data processing apparatus of claim 14, wherein each of the slice edge deblock filters receives pieces of information, informing that the deblock filtering for the at least two slices has been completed, from at least two neighboring encoders of a number of the encoders, loads data of a boundary portion between the at least two slices from a frame buffer based on the received information, and deblock-filters the loaded data.

18. The video data processing apparatus of claim 11, wherein each of the slice edge deblock filters deblock-filters a boundary portion between neighbor slices of a number of the slices and sends deblock-filtered data to a frame buffer.

19. A video data processing method, comprising:
receiving a frame image divided into a number of slices and encoding the received frame image on a slice basis;
decoding a number of the encoded slices in order to use the frame image in encoding another frame;
deblock-filtering a number of the decoded slices except boundary portions between the decoded slices; and
in parallel deblock-filtering the boundary portions between a number of the decoded slices using a number of slice edge deblock filters.

20. The video data processing method of claim 19, wherein in parallel deblock-filtering the boundary portions between a number of the decoded slices using a number of slice edge deblock filters comprises, using each of the slice edge deblock filters:
determining whether the deblock filtering for two neighbor slices of a number of the decoded slices has been completed; and
if, as a result of the determination, the deblock filtering for the two neighbor slices is determined to have been completed, deblock-filtering a boundary portion between the two neighbor slices using a corresponding slice edge deblock filter.
